(19) United States
(12) Patent Application Publication
(10) Pub. No.: US 2026/0063973 A1
(43) Pub. Date: Mar. 5, 2026

(54) CAMERA ACCESSORY AND CAMERA SYSTEM

(71) Applicant: Shenzhen YONGNUO Electronic Equipment Co., Ltd., Shenzhen (CN)

(72) Inventors: Ying ZHUANG, Shenzhen (CN); Yongxiao ZHUANG, Shenzhen (CN); Guanfei LIANG, Shenzhen (CN); Yongsheng ZHUANG, Shenzhen (CN)

(21) Appl. No.: 19/385,072

(22) Filed: Nov. 10, 2025

Related U.S. Application Data
(63) Continuation of application No. PCT/CN2023/093324, filed on May 10, 2023.

(51) Int. Cl. G03B 17/14

(52) U.S. Cl. CPC G03B 17/14

(57) ABSTRACT

The present application discloses a camera accessory and camera system configured to be mounted to a camera body having a first mounting seat; the camera accessory comprises: an accessory housing; a second mounting seat, arranged at an end of the accessory housing, configured to snap-fitted to the first mounting seat; a latch structure, arranged on the second mounting seat, configured to engage with a structure on the first mounting seat to restrict rotation of the second mounting seat relative to the first mounting seat; an unlocking button, arranged on a side surface of the accessory housing, connected to the latch structure, for releasing the engagement between the latch structure and the first mounting seat. The present application provides an unlocking button on the camera accessory that allows the camera accessory to be detached while unlocking, thereby facilitating user operation.

### TECHNICAL FIELD

This application relates to the field of camera technology, and particularly to a camera accessory and camera system.

### BACKGROUND

In the related art, a pin structure on the camera body is typically utilized in conjunction with a pin slot on the camera accessory to achieve locking between the camera accessory and the camera body, restricting relative rotation after the camera accessory is installed on the camera body. However, the pin structure is too small, resulting in poor locking performance and inadequate stability. Unlocking is achieved by utilizing a button on the camera body to release the pin structure. During operation, users must use one hand to press the button on the camera body and the other hand to remove the camera accessory, making the operation inconvenient.

Camera accessories are mounted to the camera body through rotational engagement. In addition to mechanical connection, electrical connection is achieved through contacts. To realize electrical communication, multiple contacts are typically arranged in circumferential distribution. Consequently, during the rotational process, the contacts on the camera accessory and the contacts on the camera body experience frictional contact, which readily causes wear and false triggering between the contacts.

### SUMMARY

The present application provides a camera accessory and camera system to address stability issues and other problems in related camera technologies.

The present application provides a camera accessory configured to be mounted to a camera body having a first mounting seat, wherein the first mounting seat comprises a plurality of first claws. The camera accessory comprises: a second mounting seat, the second mounting seat comprising a plurality of second claws; the second mounting seat being configured to rotate relative to the first mounting seat between a first state and a second state, wherein in the first state, the second claws are each inserted between the first claws; wherein in the second state, the second claws engage with the first claws; a latch structure, wherein the latch structure is movably arranged on an outer ring surface of the second mounting seat that engages with the first claw, and when the second mounting seat rotates relative to the first mounting seat between the first state and the second state, the latch structure retracts into the outer ring surface; when the second mounting seat is in the second state relative to the first mounting seat, the latch structure projects from the outer ring surface and engages with the first claw to restrict the second mounting seat from rotating from the second state to the first state.

According to the camera accessory of the present application, the camera accessory is capable of achieving secure locking by utilizing claws on the camera body. The camera accessory and camera body achieve engagement through claws, and after engagement, locking between the two is achieved through a latch structure that restricts relative rotation. The latch structure arranged on the camera accessory specifically engages with the claws on the camera body, and due to the inherent stability of the claws, the present application achieves secure locking.

The present application provides a camera accessory, wherein the camera accessory is configured to be mounted to a camera body having a first mounting seat; the camera accessory comprises: an accessory housing; a second mounting seat, arranged at an end of the accessory housing, configured to engage and connect with the first mounting seat; a latch structure, arranged on the second mounting seat, configured to engage with a structure on the first mounting seat to restrict rotation of the second mounting seat relative to the first mounting seat; an unlocking button, arranged on a side surface of the accessory housing, connected to the latch structure, for releasing the engagement between the latch structure and the first mounting seat.

According to the camera accessory of the present application, by providing an unlocking button on the camera accessory, the camera accessory can be detached while unlocking simultaneously, thereby facilitating user operation.

The present application provides a camera accessory, wherein the camera accessory is configured to be mounted to a camera body having a first mounting seat. The camera accessory comprises: a second mounting seat configured to engage and connect with the first mounting seat; a contact holder arranged on an inner ring surface of the second mounting seat and movably arranged relative to the second mounting seat in the axial direction of the camera accessory; contacts are arranged on the contact holder and configured for electrical connection with the camera body; a lifting member arranged on the outer ring surface of the second mounting seat and connected to the contact holder; The lifting member is configured to move axially relative to the second mounting seat under the action of the first mounting seat, so as to drive the contact holder to move in the axial direction.

According to the camera accessory of the present application, the contact holder can move axially up and down for electrical connection with the camera body after the second mounting seat is rotated into position, thereby avoiding friction between contacts during the rotation process and preventing wear.

The present application provides a camera accessory, wherein the camera accessory is configured to be mounted to a camera body having a first mounting seat. The camera accessory comprises: a second mounting seat configured to engage and connect with the first mounting seat; a contact holder, rotatably arranged on the inner ring surface of the second mounting seat, wherein contacts are arranged on the contact holder and configured to be electrically connected to the camera body; a guide structure, arranged between the contact holder and the second mounting seat; when the contact holder rotates relative to the second mounting seat, the contact holder moves in the axial direction of the camera accessory under an action of the guide structure.

According to the camera accessory of the present application, the contact holder in the camera accessory can move axially up and down by means of rotation of the second mounting seat, wherein electrical connection with the camera body can be achieved by rising and descending after the second mounting seat rotates relative to the first mounting seat into position, thereby avoiding contact wear during the rotation process.

The present application provides a camera accessory configured to be mounted to a camera body having a first mounting seat; the camera accessory comprises: an accessory housing; a second mounting seat arranged at an end of the accessory housing, the second mounting seat being configured to engage and connect with the first mounting seat; a contact assembly arranged on an inner ring surface of the second mounting seat, the contact assembly comprising contacts being configured to electrically connect with the camera body; a control circuit board arranged within the accessory housing, the second mounting seat being electrically connected to a ground terminal of the control circuit board.

According to the camera accessory of the present application, the camera accessory utilizes the mounting seat to achieve grounding. Since the mounting seat has a large contact surface and experiences minimal wear during installation, utilizing the mounting seat for grounding electrical connection enables a more stable connection.

The present application provides a camera accessory configured to be mounted to a camera body having a first mounting seat, wherein the first mounting seat is provided with a plurality of first contacts, and the plurality of first contacts have height difference in an axial direction of the first mounting seat. The camera accessory comprises: a second mounting seat configured to engage and connect with the first mounting seat; a contact holder arranged on the inner ring surface of the second mounting seat; wherein the holding surface of the contact holder facing the first mounting seat is provided with a plurality of second contacts, the second contacts being configured to electrically connect with the first contacts; the second contacts are flush with the holding surface, wherein the holding surface comprises a smooth surface formed according to a height variation trend of the plurality of first contacts.

In accordance with the camera accessory of the present application, the camera accessory can be adapted for use with a camera body having contacts with height differentials, featuring simplified manufacturing processes and reduced cost.

This application provides a camera system comprising the aforementioned camera accessory and a camera body adapted to the camera accessory.

### BRIEF DESCRIPTION OF THE DRAWINGS

FIG. 1 is a structural schematic diagram of the camera accessory and camera body of the present application;

FIG. 2 is a structural schematic diagram of the first embodiment of the camera accessory of the present application;

FIG. 3 is another structural schematic diagram of the first embodiment of the camera accessory shown in FIG. 2;

FIG. 4 is a schematic diagram showing the latch structure retracted into the outer ring surface in the first embodiment of the camera accessory shown in FIG. 2;

FIG. 5 is a structural schematic diagram of the linkage structure in the first embodiment of the camera accessory shown in FIG. 2;

FIG. 6 is a structural schematic diagram of the second embodiment of the camera accessory of the present application;

FIG. 7 is another structural schematic diagram of the second embodiment of the camera accessory shown in FIG. 6;

FIG. 8 is a structural schematic diagram of the third embodiment of the camera accessory of the present application;

FIG. 9 is a structural schematic diagram of the latch structure in the third embodiment of the camera accessory shown in FIG. 8;

FIG. 10 is another schematic diagram of the acting surface of the first claw on the latch structure in the first embodiment of the camera accessory shown in FIG. 2;

FIG. 11 is a structural schematic diagram of the fourth embodiment of the camera accessory of the present application;

FIG. 12 is a structural schematic diagram of the contact holder positioned at the second position relative to the second mounting seat in the fourth embodiment of the camera accessory shown in FIG. 11;

FIG. 13 is a structural schematic diagram of the contact holder positioned at the first position relative to the second mounting seat in the fourth embodiment of the camera accessory shown in FIG. 11;

FIG. 14 is a structural schematic diagram of the fifth embodiment of the camera accessory of this application;

FIG. 15 is a structural schematic diagram from a first perspective showing the contact holder positioned at the first position relative to the second mounting seat in the fifth embodiment of the camera accessory shown in FIG. 14;

FIG. 16 is a structural schematic diagram from a second perspective showing the contact holder positioned at the first position relative to the second mounting seat in the fifth embodiment of the camera accessory shown in FIG. 14;

FIG. 17 is an exploded view of the contact holder and the second mounting seat in the fifth embodiment of the camera accessory shown in FIG. 14;

FIG. 18 is a structural schematic diagram of the sixth embodiment of the camera accessory of this application;

FIG. 19 is a structural schematic diagram from another perspective of the sixth embodiment of the camera accessory shown in FIG. 18;

FIG. 20 is a structural schematic diagram from a first perspective of the seventh embodiment of the camera accessory of the present application;

FIG. 21 is a structural schematic diagram from a second perspective of the seventh embodiment of the camera accessory shown in FIG. 20;

FIG. 22 is a structural schematic diagram from a third perspective of the seventh embodiment of the camera accessory shown in FIG. 20;

FIG. 23 is an exploded structural schematic diagram of the eighth embodiment of the camera accessory of the present application;

FIG. 24 is a structural schematic diagram of the ninth embodiment of the camera accessory of the present application;

FIG. 25 is another structural schematic diagram of the tenth embodiment of the camera accessory shown in FIG. 24.

### DETAILED DESCRIPTION

The technical solutions in the embodiments of the present application will be clearly and completely described below in conjunction with the accompanying drawings in the embodiments of the present application. It is to be understood that the specific embodiments described herein are merely for explaining the present application and are not intended to limit the present application. It should also be noted that, for convenience of description, the accompanying drawings show only those portions related to the present application rather than the complete structure. Based on the embodiments in the present application, all other embodiments obtained by persons of ordinary skill in the art without making creative efforts shall fall within the protection scope of the present application.

Reference to an “embodiment” herein means that a particular feature, structure, or characteristic described in connection with the embodiment may be included in at least one embodiment of the present application. The appearance of this phrase at various locations in the specification does not necessarily refer to the same embodiment, nor are they independent or alternative embodiments that are mutually exclusive with other embodiments. Those skilled in the art understand, both explicitly and implicitly, that the embodiments described herein may be combined with other embodiments.

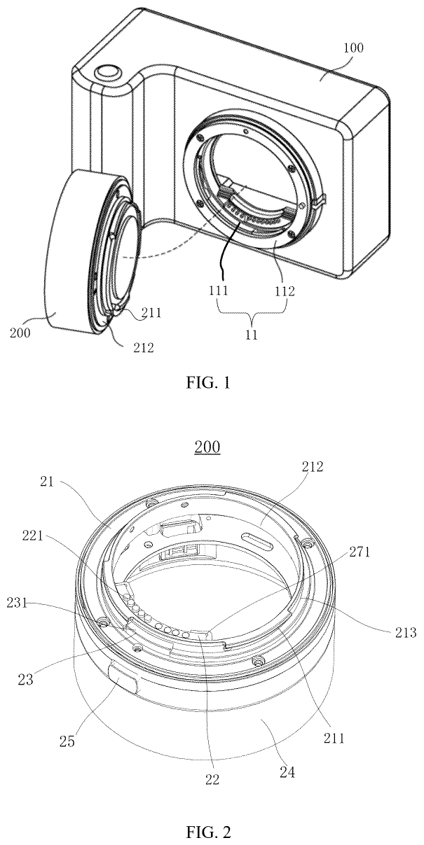

Please refer to FIG. 1, which is a structural schematic diagram of the camera accessory and camera body of this application, namely a structural schematic diagram of the camera system. The camera accessory 200 of this application is configured to be mounted to a camera body 100 having a first mounting seat 11, wherein the camera accessory 200 and camera body 100 may have multiple mounting configurations.

In this embodiment, the first mounting seat 11 comprises a plurality of first claws 111. The camera accessory 200 comprises a second mounting seat 21, wherein the second mounting seat 21 comprises a plurality of second claws 211. The second mounting seat 21 rotates relative to the first mounting seat 11 between a first state and a second state, wherein in the first state, the second claws 211 are each inserted between the first claws 111. In the second state, the second claws 211 engage with the first claws 111.

In this application, the camera body 100 and the camera accessory 200 are arranged separately, wherein the camera accessory 200 is detachably mounted on the camera body 100. The camera accessory 200 may be a lens or an adapter ring, wherein if the camera accessory 200 is a lens, it can be directly connected to the camera body 100 to form a photographic camera; if configured as an adapter ring, lenses with different mounts are connected to the camera body 100 to form a photographic camera.

The camera body 100 and camera accessory 200 are mounted through cooperative engagement of mounting seats, wherein the first mounting seat 11 of the camera body 100 comprises a plurality of first claws 111, the second mounting seat 21 of the camera accessory 200 comprises a plurality of second claws 211, and the first mounting seat 11 and second mounting seat 21 achieve insertion, engagement and detachment between the first claws 111 and second claws 211 through rotational movement.

Specifically, the second mounting seat 21 rotates relative to the first mounting seat 11 between a first state and a second state, wherein the first state constitutes the insertion and detachment state, and the second claws 211 are each inserted between the first claws 111, such that when the first mounting seat 11 comprises three first claws 111, three first claw slots are formed between the first claws 111. The second mounting seat 21 comprises three second claws 211, wherein the three second claws 211 are inserted into three first claw slots to achieve embedding engagement. The second state constitutes the engagement state, wherein the camera accessory 200 and the camera body 100 complete docking installation. In this configuration, the second claw 211 engages with the first claw 111, whereby after the second claw 211 is inserted between the first claws 111, it rotates to overlap with the first claw 111, thereby achieving mechanical engagement between them and enabling the camera accessory 200 to be securely fixed to the camera body 100.

The camera accessory 200 and camera body 100, interconnected through claw member engagement, utilize the engaging force between the claws to support the weight of the camera accessory 200. Therefore, the first mounting seat 11 and the second mounting seat 21 have high strength requirements, generally utilizing metal materials, although high-strength plastic materials may also be selected.

The camera accessory 200 and camera body 100 can be axially engaged and fixed through the claws. To enable stable camera operation, circumferential movement between the camera accessory and camera body must be locked to prevent relative rotation. Accordingly, the camera accessory in this application is further provided with a latch structure.

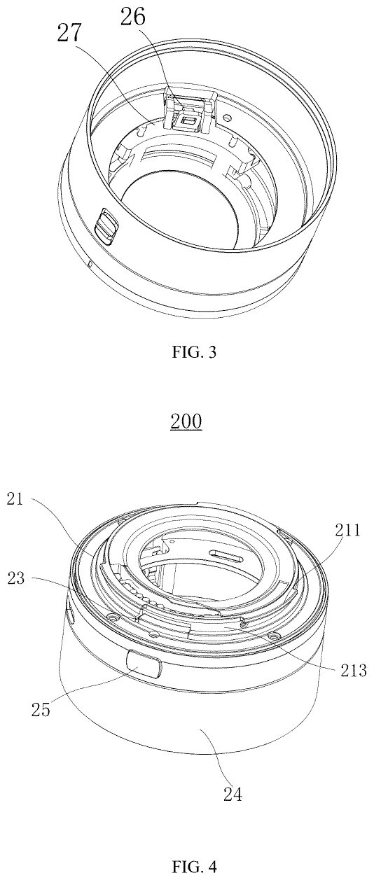

Reference is made specifically to FIGS. 2-5, wherein FIG. 2 is a structural schematic diagram of the first embodiment of the camera accessory of this application, FIG. 3 is another structural schematic diagram of the first embodiment of the camera accessory shown in FIG. 2, FIG. 4 is a schematic diagram showing the latch structure retracted into the outer ring surface in the first embodiment of the camera accessory shown in FIG. 2, and FIG. 5 is a structural schematic diagram of the linkage structure in the first embodiment of the camera accessory shown in FIG. 2. The camera accessory 200 comprises a latch structure 23.

The second mounting seat 21 is annular in configuration, comprising an inner ring surface 212 and an outer ring surface 213. The latch structure 22 is movably arranged on the outer ring surface 213 of the second mounting seat 21 that engages with the first claw 111, wherein when the second mounting seat 21 rotates relative to the first mounting seat 11 between the first state and the second state, the latch structure 22 retracts into the outer ring surface 213. When the second mounting seat 21 is in the second state relative to the first mounting seat 11, the latch structure 23 projects from the outer ring surface 213 and engages with the first claw 111 to restrict the second mounting seat 21 from rotating from the second state to the first state.

In the present embodiment, the latch structure 23 utilizes the first claw 111 to achieve rotational locking. Specifically, when the first mounting seat 11 and the second mounting seat 21 are installed through relative rotation, the first claw 111 and the second claw 211 are in a mutually hooked state. The second mounting seat 21 further comprises an outer ring surface 213 that engages with the first claw 111 in the circumferential direction. The first claw 111 rotates along the outer ring surface 213 in the circumferential direction relative to the second claw 211. Therefore, to limit the rotation between the two claws, the latch structure 23 is movably arranged on the outer ring surface 213. When permitting relative rotation between the two claws, namely when the second mounting seat 21 rotates relative to the first mounting seat 11 between the first state and the second state, the latch structure 23 retracts into the outer ring surface 213 to avoid interference. When restricting the relative rotation of the two claws, namely when the second mounting seat 21 is in the second state relative to the first mounting seat 11, the latch structure 23 projects from the outer ring surface 213 to engage with the first claw 111, abutting against the end of the first claw 111 to prevent rotation thereof.

Multiple structural designs exist for achieving the extension and retraction movement of the latch structure 23, wherein different structural designs may be operated by the user or completed automatically by the structure itself. In the present embodiment, when it is necessary to replace the camera accessory 200 for the camera, unlocking in the second state is necessary to enable the camera accessory 200 to rotate relative to the camera body 100 to the first state for detachment, wherein an unlocking structure is further provided on the camera accessory 200.

Specifically, the camera accessory 200 further comprises an accessory housing 24 and an unlocking button 25, wherein the second mounting seat 21 is arranged at an end of the accessory housing 24, the unlocking button 25 is arranged on a side surface of the accessory housing 24 and connected to the latch structure 23, acting upon the latch structure 23 to cause the latch structure 23 to retract into the outer ring surface 213, thereby disengaging the latch structure 23 from the first claw 111.

The accessory housing 24 constitutes the housing of the camera accessory 200, with the second mounting seat 21 arranged at the end of the accessory housing 24. When the camera accessory 200 comprises a lens, the accessory housing 24 further accommodates structures comprising an optical lens module and circuit boards. If the camera accessory 200 is an adapter ring, one end is provided with a second mounting seat 21 that mates with the camera body 100, and the other end is provided with a mounting seat that mates with an adapter lens, wherein a circuit structure may also be arranged therein.

The unlocking button 25 is connected to the latch structure 23 and acts upon the latch structure 23 to cause the latch structure 23 to retract into the outer ring surface 213, thereby releasing the engagement between the latch structure 23 and the first claw 111. The unlocking button 25 is provided for user operation, wherein when the user presses the unlocking button 25, the movement of the unlocking button 25 drives the latch structure 23 to retract into the outer ring surface 213, thereby enabling the camera accessory 200 to be unlocked in the second state. The second mounting seat 21 is connected to the first mounting seat 11 and is not exposed externally during camera use. Therefore, the unlocking button 25 is positioned on the side surface of the accessory housing to facilitate user operation.

Furthermore, the unlocking button 25 is located on the camera accessory 200, whereby when detachment of the camera accessory 200 is required, the user can simultaneously press the unlocking button 25 and rotate the camera accessory 200 with one hand to achieve detachment. However, if the unlocking button 25 were positioned on the camera body 100, it would require the user to press the unlocking button on the camera body 100 with one hand while rotating the camera accessory 200 with the other hand. In this application, the configuration wherein the unlocking button 25 is arranged on the camera accessory 200 provides more convenient operation.

To reduce user operations and improve user experience, when the camera accessory 200 is inserted into the camera body 100 in the first state and rotated from the first state to the second state, during the engagement process in the second state, this embodiment achieves automatic engagement through the structural design of the latch structure 23 itself.

Specifically, the latch structure 23 is elastically and movably arranged relative to the outer ring surface 212 in the axial or radial direction of the camera accessory 200. When the second mounting seat 21 rotates relative to the first mounting seat 11 between the first state and the second state, the latch structure 23 is pressed into the outer ring surface 213 by the first claw 111. When the second mounting seat is in the second state relative to the first mounting seat, the latch structure 23 springs out from the outer ring surface 213.

The elastic movable configuration of the latch structure 23 enables automatic engagement, wherein the latch structure 23 projects from the outer ring surface 213 when no external force is applied, and the latch structure 23 can be pressed into the outer ring surface when external force is applied. The automatic engagement of the latch structure can be achieved by utilizing the movement between the first mounting seat 11 and the second mounting seat 21 and their structural configuration.

When installing the camera accessory 200, the second mounting seat 21 must first be inserted into the first mounting seat 11, at which time axial movement exists between the two components. Subsequently, the second mounting seat 21 must rotate relative to the first mounting seat 11, at which time circumferential movement exists between the two components. Therefore, these two movements can be utilized to achieve retraction of the latch structure 23 into the outer ring surface in the axial or radial direction, specifically by utilizing the first claw 111 to press the latch structure 23 into the outer ring surface 213, and since the first claw 111 is an arc segment, when rotated to the second state, the latch structure 23 moves to the position between the first claws, no longer subject to the force from the first claw 111, and can return to project from the outer ring surface 213 under elastic force, thereby achieving locking.

Based on this principle, since there is a plurality of first claws, each first claw in this application can cooperate with the latch structure 23 to achieve locking. The corresponding unlocking button 25 is positioned relative to the latch structure 23, enabling the unlocking button 25 to be arranged at a location convenient for thumb actuation. For example, by utilizing the first claw positioned above the horizontal centerline when the camera is used horizontally to cooperate with the latch structure 23, with the unlocking button 25 and the latch structure 23 arranged in the same radial direction, the position of the unlocking button 25 facilitates user thumb actuation, thereby enhancing operational convenience.

In this embodiment, the latch structure 23 is elastically and movably arranged relative to the outer ring surface 213 in the axial direction of the camera accessory 200. A linkage structure 26 is arranged between the unlocking button 25 and the latch structure 23, wherein the unlocking button 25 moves in the radial direction to drive the latch structure 23 to move in the axial direction through the linkage structure.

The unlocking button 25 is arranged on the side surface of the accessory housing 24, with its movement direction configured as radial, therefore the linkage structure 26 functions to convert the radial movement of the unlocking button 25 into axial movement of the latch structure 23.

The linkage structure 26 comprises a V-shaped transmission member 26, wherein the V-shaped transmission member 26 is rotatably mounted at its pivot point on the second mounting seat 21, with one end connected to the latch structure 23 and the other end connected to the unlocking button 25. The V-shaped transmission member 26 is configured to achieve motion direction conversion, with its pivot point rotatably mounted, such that when the V-shaped transmission member rotates about the pivot point, the two ends of the V-configuration can move in different directions.

The linkage structure 26 further cooperates with the guide portion 27 fixed to the second mounting seat 21 to facilitate movement of the latch structure 23, wherein the pivot point of the V-shaped transmission member 26 is rotatably mounted on the guide portion 27. The guide portion 27 serves to constrain the direction of movement of the latch structure 23 and comprises an axial guide groove 271, wherein the latch structure 23 is arranged within the axial guide groove 271 to enable axial movement along the guide groove 271.

To provide elastic return positioning of the latch structure 23, a return snap spring is arranged at the rotational connection between the V-shaped transmission member 26 and the guide portion 27, such that in the natural state of the return snap spring, the latch structure 23 projects from the outer ring surface 213.

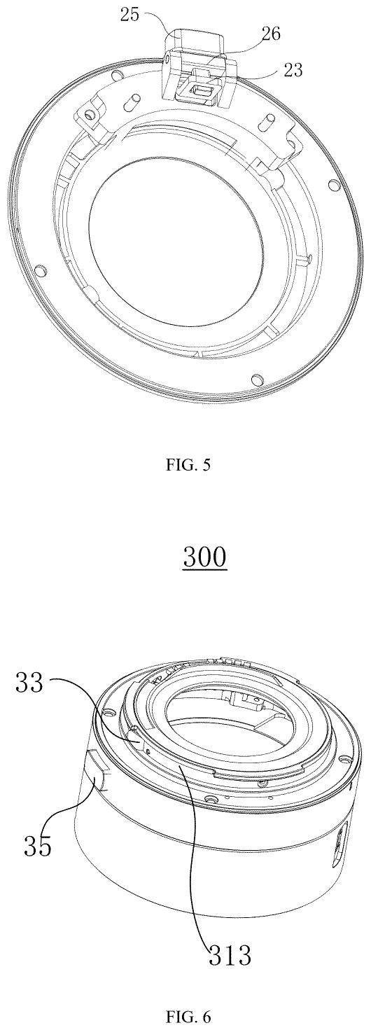

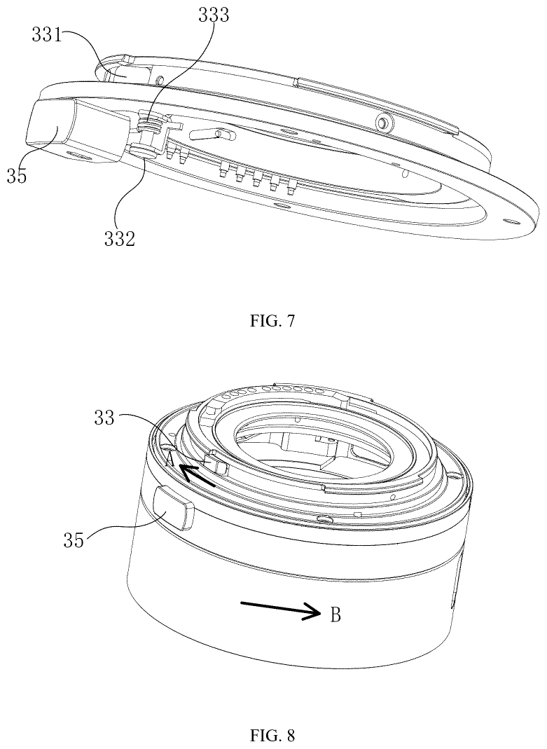

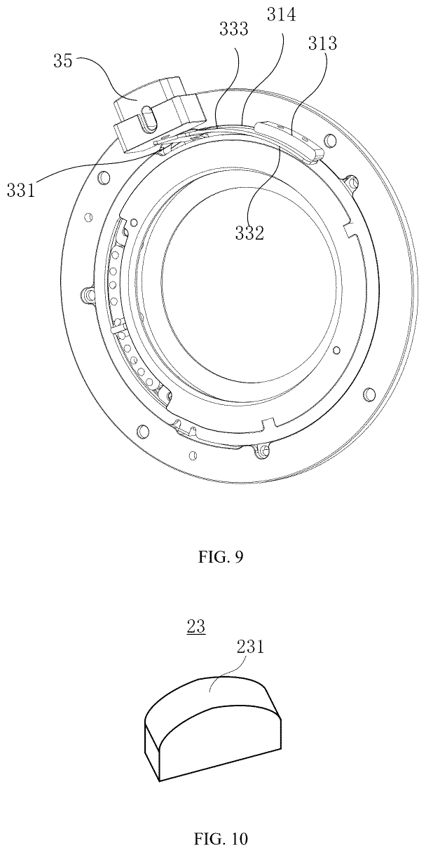

In other embodiments, the latch structure is elastically and movably arranged relative to the outer ring surface in the radial direction of the camera accessory. Specifically as illustrated in FIGS. 6-7 and FIGS. 8-9, FIG. 6 is a structural schematic diagram of the second embodiment of the camera accessory of the present application, and FIG. 7 is another structural schematic diagram of the second embodiment of the camera accessory shown in FIG. 6; FIG. 8 is a structural schematic diagram of the third embodiment of the camera accessory of the present application, and FIG. 9 is a structural schematic diagram of the latch structure in the third embodiment of the camera accessory shown in FIG. 8.

In FIGS. 6-9, the camera accessory components are designated with series numbering beginning with 300, with reference numerals corresponding to those in the embodiment illustrated in FIGS. 2-5. The latch structure 33 in camera accessory 300 is movably arranged relative to the outer ring surface 313 in the radial direction of the camera accessory 300.

The camera accessory 300 in this embodiment is substantially identical to the camera accessory 200 in the aforementioned embodiment, with the difference being the configuration of the latch structure 33, wherein in this embodiment the latch structure 33 is movably arranged in the radial direction relative to the outer ring surface 313. The unlocking button 35 abuts against the latch structure 33, wherein the unlocking button 35 moves radially, thereby driving the latch structure 33 to move radially.

The latch structure 33 comprises a latching portion 331, a fixing portion 332, and a return elastic member 333, wherein the fixing portion 332 is fixedly connected to the second mounting seat 31, the latching portion 331 is connected to the fixing portion 332 through the return elastic member 333, one end of the latching portion 331 extends and retracts relative to the outer ring surface 313 while the other end abuts against the unlocking button 35, and in the natural state of the return elastic member 333, the latching portion 331 projects from the outer ring surface 313.

The latch structure 33 may take various forms. As shown in FIGS. 6-7, the return elastic member 333 is a snap ring, the latching portion 331 is rotatably arranged on the fixing portion 332, and the return elastic member 333 serving as the snap ring is fitted onto the fixing portion, abutting against the latching portion 331 and the fixing portion 332.

As shown in FIGS. 8-9, the latch structure 33 comprises an elastic plate, wherein the first end of the elastic plate serves as the latching portion 331, the second end serves as the fixing portion 332, and the elastic portion 333 is arranged between the two ends.

The elastic plate is primarily arranged on the end surface of the second mounting seat 31 facing away from the first mounting seat. The second mounting seat 31 is further provided with a fixing post 313 and a limiting groove 314, wherein the second end of the elastic plate is fixed to the fixing post 313, the elastic plate is embedded within the limiting groove 314, and the limiting groove 314 serves to restrict outward expansion of the elastic plate.

For the two embodiments in FIGS. 6-9, the latching portion 331 extends circumferentially from the outer ring surface 313 in direction A, which is opposite to the installation rotation direction B of the camera accessory 300 relative to the camera body 100, and the latching portion 321 is inclined upward in direction A. When the camera accessory 300 is mounted on the camera body and rotates relative to the camera body 100, the first claw 11 can act along the latching portion 331 to press the latching portion 331 into the outer ring surface 313.

In summary, the camera accessory of FIGS. 2-9 is configured to be mounted to a camera body having a first mounting seat, wherein the first mounting seat comprises a plurality of first claws. The camera accessory comprises: a second mounting seat, wherein the second mounting seat comprises a plurality of second claws. The second mounting seat rotates relative to the first mounting seat between a first state and a second state, wherein in the first state, the second claws are each inserted between the first claws; in the second state, the second claws engage with the first claws; a latch structure, wherein the latch structure is movably arranged on an outer ring surface of the second mounting seat that engages with the first claws, and when the second mounting seat rotates relative to the first mounting seat between the first state and the second state, the latch structure retracts into the outer ring surface; when the second mounting seat is in the second state relative to the first mounting seat, the latch structure projects from the outer ring surface and engages with the first claws to restrict the second mounting seat from rotating from the second state to the first state. The camera accessory of the present application is capable of achieving secure locking by utilizing the claws on the camera body. The camera accessory and camera body achieve engagement through claws, and after engagement, locking between the two is achieved through a latch structure that restricts relative rotation. The latch structure arranged on the camera accessory specifically engages with the claws on the camera body, and due to the inherent stability of the claws, the present application achieves secure locking.

The present application further provides a camera accessory. Referring again to FIG. 2 and FIG. 3, the outer ring surface 213 of the second mounting seat 21 engages with the first mounting seat 11, and the inner ring surface 212 is provided with electrical connection contacts.

The camera accessory 200 further comprises a contact holder 22 and a lifting member 23, wherein the aforementioned latch structure 23 functions as the lifting member. The contact holder 22 is arranged on the inner ring surface 212 of the second mounting seat 21 and is movably arranged relative to the second mounting seat 21 in the axial direction of the camera accessory 200. The contact holder 22 is configured to carry contacts 221, which are configured to establish electrical connection with the camera body 100.

The lifting member 23 is arranged on the outer ring surface of the second mounting seat 21 and connected to the contact holder 22. During the mounting process of the camera accessory 200 and the camera body 100, the first mounting seat 11 acts upon the lifting member 23, causing it to move axially relative to the second mounting seat 21, thereby driving the contact holder 22 to move axially.

Specifically, when the second mounting seat 21 is in the first state or between the first state and the second state relative to the first mounting seat 11, the lifting member 23, under the action of the first claw 111, drives the contact holder 22 to move in a direction away from the first mounting seat 11. When the second mounting seat 21 is in the second state relative to the first mounting seat 11, the contact 221 on the contact holder 22 electrically connects to the camera body 100.

Specifically, when the camera accessory 200 is mounted to the camera body 100, the second mounting seat 21 rotates relative to the first mounting seat 11 from the first state to the second state. In non-second states, namely in the first state or between the first state and the second state, the lifting member 23, under the action of the first claw 111, drives the contact holder 22 to move in a direction away from the first mounting seat 11, such that an axial clearance exists between the contact holder 22 and the camera body 100. Consequently, during rotation, the contacts 221 on the contact holder 22 and the contacts on the camera body 100 do not make contact, thereby preventing wear.

After the second mounting seat 21 rotates to the second state, the contact holder 22 subsequently moves toward the first mounting seat 11, achieving contact with the camera body and thereby establishing electrical connection.

In this application, the axial movement of the lifting member 23 can be achieved utilizing driving structures such as manual toggle levers. In this embodiment, the axial movement of the lifting member 23 is specifically achieved utilizing a return elastic member, wherein the return elastic member is arranged between the lifting member 23 and the second mounting seat 21.

When the return elastic member is in its natural state, the lifting member 23 projects from the outer ring surface 213. When the second mounting seat 21 is positioned in the first state or transitioning between the first state and the second state relative to the first mounting seat 11, the lifting member 23, under the action of the first claw 111, retracts axially into the outer ring surface 213, thereby driving the contact holder 22 to move in a direction away from the first mounting seat 11, whereupon the return elastic member generates elastic force. When the second mounting seat 21 rotates to the second state, the first claw 111 no longer acts upon the lifting member 23, and the lifting member 23 returns to project from the outer ring surface 213 under the action of the return elastic member, thereby driving the contact holder 22 to move toward the first mounting seat 11.

In this embodiment, the structure of the lifting member 23 itself can also be utilized to achieve axial movement, as specifically shown in FIG. 10, which is another schematic diagram of the acting surface of the first claw on the lifting member in the embodiment of the camera accessory shown in FIG. 2.

In FIG. 10, the acting surface 231 of the first claw 111 on the lifting member 23 is an axially protruding smooth convex surface. When the second mounting seat 21 rotates relative to the first mounting seat 11 between the first state and the second state, the first claw 111 acts on the acting surface 231, causing the lifting member 23 to be gradually pressed into the outer ring surface 213 and then gradually projected from the outer ring surface, thereby driving the contact holder 22 to first move in a direction away from the first mounting seat 11, and then move in a direction toward the first mounting seat.

This process can also ensure that during rotation, a predetermined clearance is maintained between the contact holder 22 and the camera body 11, thereby preventing contact wear between the contacts 221 on the contact holder 22 and the contacts on the camera body 11 during the rotation process. Upon final rotation to the second state, the lifting member 23 projects from the outer ring surface 213, whereupon the contacts 221 on the contact holder 22 engage with the contacts on the camera body 11, thereby establishing electrical connection.

In the embodiment illustrated in FIGS. 2-3, the acting surface 231 of the lifting member 23 comprises a plane perpendicular to the axial direction, wherein the second mounting seat 21 relative to the first mounting seat 11 is pressed into the outer ring surface 213 by the first claw 111 in the first state; during the rotational transition from the first state to the second state, the lifting member 23 continuously maintains the state of being pressed into the outer ring surface 213 by the first claw 111; when rotated to the second state, the lifting member 23 is no longer actuated by the first claw 111 and can project from the outer ring surface 213, thereby driving the contact holder 22 toward the first mounting seat 11. Specifically, the lifting member projects from the outer ring surface 213 under the action of the return elastic member.

In other embodiments, the acting surface 231 may also comprise an inclined surface, wherein the first claw 111 acts upon the inclined surface to gradually press the lifting member 23 into the outer ring surface 213 during the rotation process. Upon reaching the second state, the lifting member 23 is no longer actuated by the first claw and can project from the outer ring surface 213, thereby driving the contact holder 22 toward the first mounting seat 11. Specifically, the lifting member projects from the outer ring surface 213 under the action of the return elastic member.

In the embodiment of this application, when the second mounting seat 21 rotates relative to the first mounting seat 11 to the second state, the lifting member 23 projects from the outer ring surface 213, positioned between the two first claws 111, and functions as a latch structure to engage with the first claw 111, thereby restricting circumferential rotation between the camera accessory 200 and the camera body 100. The lifting member 23 simultaneously achieves locking engagement and lifting of the contact holder 22, resulting in a more compact structure that facilitates user operation.

In this embodiment, the contact holder 22 and the contacts 221 are configured to correspond with the contacts on the camera body 100, wherein if the multiple contacts on the camera body are arranged in a planar configuration, they are positioned at the same height. The surface of the contact holder 22 facing the first mounting seat 11 is also planar, wherein the contact 221 may be cylindrical and inserted within the contact holder 22 to be flush with the surface; Alternatively, the contact 221 may be sheet-shaped and attached to the surface.

Where multiple contacts on the camera body have height difference, the surface of the contact holder 22 may comprise a surface with corresponding height difference, wherein the contacts 221 may similarly be cylindrical or sheet-shaped and positioned flush with the surface. Specifically, the height difference of the surface enable corresponding height difference of the contacts 221, thereby facilitating engagement with the height-differentiated contacts on the camera body.

The surface of the contact holder 22 may alternatively be planar, with the contacts 221 being a metal post inserted into the contact holder 22, wherein a portion of the contact 221 projects from the surface to achieve the requisite height difference among the contacts. Cylindrical contacts provide more stable electrical signal transmission performance compared to planar contacts.

In summary, the camera accessory shown in FIGS. 2-3 and FIG. 10 is configured to be mounted to a camera body having a first mounting seat. The camera accessory comprises: a second mounting seat configured to engage and connect with the first mounting seat; a contact holder arranged on the inner ring surface of the second mounting seat and movably positioned relative to the second mounting seat in the axial direction of the camera accessory; contacts are arranged on the contact holder and configured for electrical connection with the camera body; a lifting member arranged on the outer ring surface of the second mounting seat and connected to the contact holder. The lifting member is configured to move axially relative to the second mounting seat under the action of the first mounting seat, thereby driving the contact holder to move axially. The contact holder in the camera accessory of this application can move axially up and down to establish electrical connection with the camera body after the second mounting seat has rotated into position, thereby avoiding friction between contacts during rotation that would cause wear.

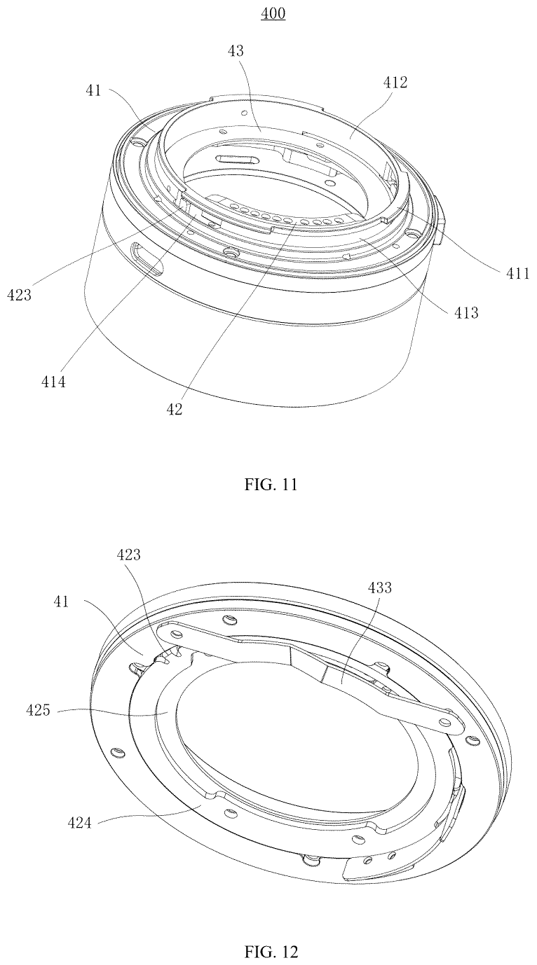

This application also proposes a camera accessory, specifically referring to FIG. 11, which is a structural schematic diagram of the fourth embodiment of the camera accessory of this application. The second mounting seat 41 on the camera accessory 400 is annular, comprising an inner ring surface 412 and an outer ring surface 413, wherein the outer ring surface 413 engages with the first mounting seat 11, and the inner ring surface 412 is provided with electrical connection contacts for electrical connection with the camera body 100.

The camera accessory 400 further comprises a contact holder 42 and a guide structure 43. The contact holder 42 is rotatably arranged on the inner ring surface 412 of the second mounting seat 41, enabling rotation relative to the second mounting seat 41. The contact holder 42 is configured to support contacts, wherein the contacts facilitate electrical connection with the camera body 100.

In this embodiment, the contact holder 42 and contacts are configured to cooperate with contacts arranged on the camera body 100, wherein when the multiple contacts on the camera body are arranged in a planar configuration at the same height; the surface of the contact holder 42 facing the first mounting seat 11 is also planar, wherein the contacts may be cylindrical and inserted into the contact holder 42 flush with the surface, or alternatively may be sheet-like and attached to the surface.

If the multiple contacts on the camera body have height differences, the surface of the contact holder 42 may comprise a surface having height difference, wherein the contacts may similarly be cylindrical or sheet-shaped and positioned flush with the surface. Specifically, the height difference of the surface enable corresponding height difference of the contacts, thereby facilitating engagement with the height-differentiated contacts on the camera body.

The surface of the contact holder 42 may alternatively be planar, with the contacts being metal posts inserted into the contact holder 42, wherein a portion of the contact projects from the surface to achieve the requisite height difference among the contacts. Cylindrical contacts provide more stable electrical signal transmission performance compared to planar contacts.

The guide structure 43 is configured for guiding the contact holder 42 to move in the axial direction and is arranged between the contact holder 42 and the second mounting seat 41. When the contact holder 42 rotates relative to the second mounting seat 41, the contact holder 42 moves in the axial direction of the camera accessory 400 under the action of the guide structure 43.

During the process of rotationally mounting the second mounting seat 41 to the first mounting seat 11, structures on the first mounting seat 11 or other related user-operated structures can be utilized to maintain the contact holder 42 and the first mounting seat 11 relatively fixed in the circumferential direction, whereby relative rotation occurs between the second mounting seat 41 and the contact holder 42, enabling the contact holder 42 to move axially relative to the first mounting seat 11 under the action of the guide structure 43.

Since the contact holder 42 is capable of axial movement, the following can be achieved: When the second mounting seat 41 rotates relative to the first mounting seat 11 between the first state and the second state, the contact holder 42 maintains a predetermined axial spacing from the first mounting seat 11, thereby preventing contact between the contact 421 on the contact holder 42 and the contact on the camera body 100 during rotation, thus eliminating wear. Prior to the second mounting seat 41 rotating relative to the first mounting seat 11 to reach the second state, the second mounting seat 41 undergoes relative movement with respect to the contact holder 42, during which process the contact holder 42 approaches the first mounting seat 11 in the axial direction, and upon reaching the second state, the contact 421 on the contact holder 42 engages with the contact on the camera body 100, thereby establishing electrical connection.

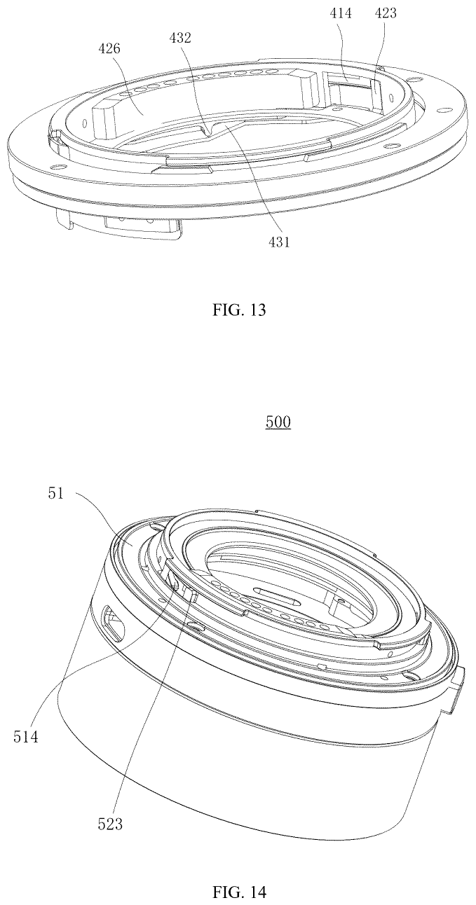

Specifically, please refer to FIGS. 12-13, wherein FIG. 12 is a structural schematic diagram of the contact holder positioned at the second position relative to the second mounting seat in the fourth embodiment of the camera accessory shown in FIG. 11, and FIG. 13 is a structural schematic diagram of the contact holder positioned at the first position relative to the second mounting seat in the fourth embodiment of the camera accessory shown in FIG. 11.

The guide structure 43 is formed with a guide surface 431, wherein the guide surface 431 extends circumferentially and is inclined axially, and the contact holder 42 abuts against the guide surface 431. Consequently, during rotation of the contact holder 42 relative to the second mounting seat 41, the axially inclined guide surface 431 generates an axial force on the contact holder 42, thereby enabling axial movement of the contact holder 42.

To enable the contact holder 42 to move toward the first mounting seat 11 during rotation from the first state to the second state, the guide surface 431 is inclined away from the first mounting seat 11 in the mounting rotation direction A of the camera accessory 400 relative to the camera body 100. The guide surface 431 comprises a proximal end adjacent to the first mounting seat 11 and a distal end remote from the first mounting seat 11. During rotation from the first state to the second state, the abutment position of the contact holder 42 translates from the distal end to the proximal end, thereby progressively approaching the first mounting seat 11 in the axial direction.

In this embodiment, the first claw effects relative fixation between the contact holder 42 and the first mounting seat 11. The contact holder 42 is connected with a locking post 423, wherein the locking post 423 projects from the outer ring surface 413 of the second mounting seat 41. During the process of the second mounting seat 41 rotating relative to the first mounting seat 11 from the first state to the second state, the first claw 111 abuts against the locking post 423, thereby causing the contact holder 42 and the first mounting seat 11 to be relatively fixed in the circumferential direction. The second mounting seat 41 can rotate relative to the contact holder 42, whereby the contact holder 42 receives an axial force to move axially toward the first mounting seat 11, achieving electrical connection with the camera body 100.

A locking hole 414 corresponding to the locking post 423 is provided on the outer ring surface 413, wherein the locking hole 414 extends circumferentially and cooperates with the locking post 423 to provide clearance for rotation of the second mounting seat 41 relative to the contact holder 42.

In this embodiment, when the second mounting seat 41 is in the first state relative to the first mounting seat 11, the contact holder 42 is positioned at the first position relative to the second mounting seat 41. When the second mounting seat 41 is in the second state relative to the first mounting seat 11, the contact holder 42 undergoes positional changes in both axial and circumferential directions relative to the second mounting seat 41 under the action of the guide structure 43 and is positioned at the second position.

During the lens removal process, the contact holder 42 may be manually moved back to the first position to prevent contact wear during removal rotation. In this embodiment, to achieve automation and facilitate user operation, a return elastic member is arranged between the contact holder 42 and the second mounting seat 41, whereby the contact holder 42 can return from the second position to the first position under the action of the return elastic member.

When the second mounting seat 41 rotates relative to the contact holder 42, the return elastic member generates elastic force, and due to the action of the first claw 111, the return elastic member maintains the elastic force. When the second mounting seat 41 is rotated for detachment, the first claw 111 no longer acts, whereby the elastic force of the return elastic member causes the contact holder 42 to return to the first position.

In the fourth embodiment shown in FIGS. 11-13, the guide structure 43 comprises a guide post 432 arranged on the contact holder 42, and a guide plate 433 arranged on the second mounting seat 41. The guide plate 433 is fixed to the end surface of the second mounting seat 41 facing away from the first mounting seat 11, the guide surface 431 is formed on the guide plate 433, and the guide post 432 abuts against the guide surface 431.

The contact holder 42 comprises a rotating ring 424, an elastic ring 425, and a holding portion 426, wherein the rotating ring 424 is rotatably engaged with the inner ring surface of the second mounting seat 41, the elastic ring 425 connects the rotating ring 424 and the holding portion 426, and the holding portion 426 is configured to mount contacts. The guide post 432 is arranged on the holding portion 426. Wherein one end of the elastic ring 425 is fixed to the rotating ring 424 and the other end is fixed to the contact holder 42, therefore the contact holder 42 can achieve circumferential rotation through the rotating ring 424 and axial movement through the elastic ring 425.

The guide structure is primarily arranged between the contact holder 42 and the second mounting seat 41. The contact relationship between the contact holder 42 and the second mounting seat 41 comprises multiple surfaces. In the aforementioned first embodiment, the guide structure is arranged axially between the contact holder 42 and the second mounting seat 41. In other embodiments, the guide structure may alternatively be arranged circumferentially between the contact holder 42 and the second mounting seat 41

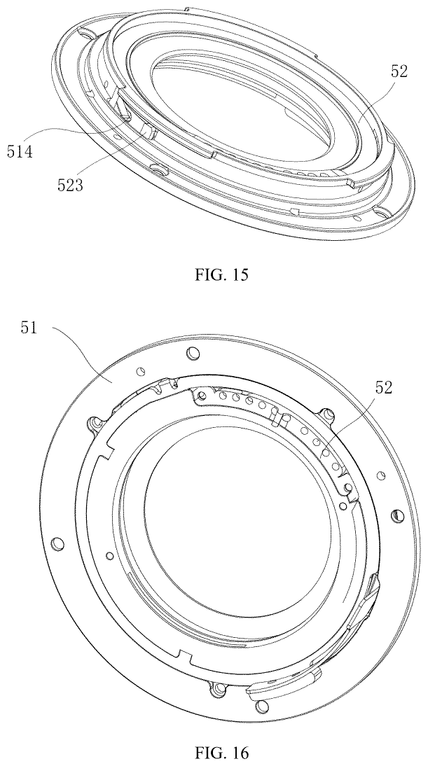

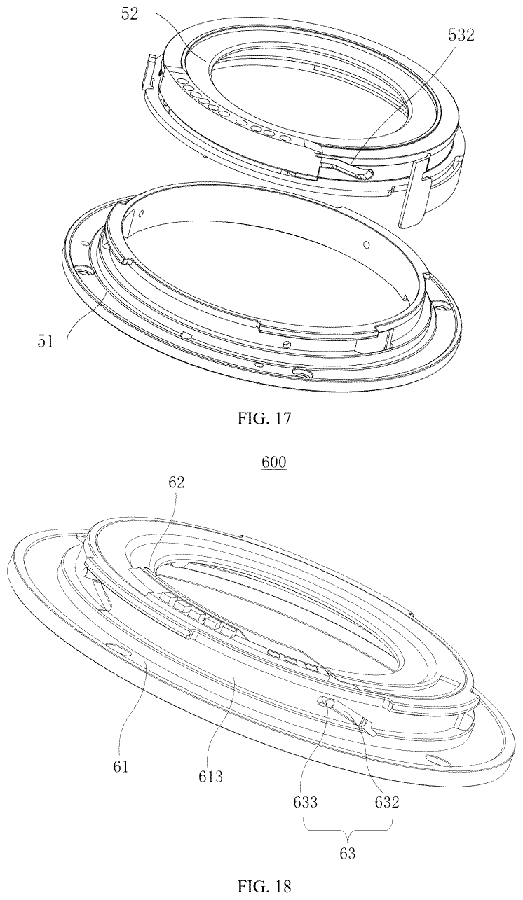

As illustrated in the fifth embodiment shown in FIGS. 14-17, FIG. 14 is a structural schematic diagram of the fifth embodiment of the camera accessory of this application, FIG. 15 is a structural schematic diagram from a first perspective showing the contact holder positioned at the first position relative to the second mounting seat in the fifth embodiment of the camera accessory shown in FIG. 14, FIG. 16 is a structural schematic diagram from a second perspective showing the contact holder positioned at the first position relative to the second mounting seat in the fifth embodiment of the camera accessory shown in FIG. 14, and FIG. 17 is an exploded view of the contact holder and second mounting seat in the fifth embodiment of the camera accessory shown in FIG. 14.

In the fifth embodiment, the camera accessory components are designated with series numbering beginning with 500, wherein each component number corresponds to the numbering in the fourth embodiment. Except for the guide structure 53 and its related structures, other structures are substantially the same as those in the first embodiment, and specific details will not be reiterated herein.

In the fifth embodiment, the guide structure 53 comprises a guide groove 532 and a guide post 533, wherein the guide groove 532 is formed in one of the second mounting seat 51 and the contact holder 52, and the guide post 533 is arranged on the other of the second mounting seat 51 and the contact holder 52. The guide post 533 is inserted through the guide groove 532, and the guide surface 531 is formed within the guide groove 532, wherein the guide groove 532 extends circumferentially and is inclined axially. To ensure stable movement of the contact holder 52, multiple sets of guide structures 53 may be provided. In this embodiment, three sets of guide structures 53 are uniformly arranged in the circumferential direction.

To facilitate assembly between the contact holder 52 and the second mounting seat 51, the guide structure 53 further comprises a mounting slot 534 that communicates with the guide groove 532. During the process of axially installing the contact holder 52 to the second mounting seat 51, the guide post 533 enters the guide groove 532 from the mounting slot 534.

To prevent the contact holder 52 from sliding out of the second mounting seat 51 through the mounting slot 534 during rotation, a limiting structure is provided between the contact holder 52 and the second mounting seat 51 to restrict movement of the guide post 533 within the guide groove 532.

The limiting structure may specifically comprise a limiting hole 514 extending circumferentially on the second mounting seat 51, and a limiting post 523 arranged on the contact holder 52, wherein the limiting post 523 is inserted into the limiting hole 514. The limiting post 523 and limiting hole 514 may simultaneously serve as the locking post 523 and locking hole 514 as in the first embodiment.

As in the first embodiment, in the second embodiment, a return elastic member is further arranged between the contact holder 52 and the second mounting seat 51, wherein in this embodiment, the return elastic member is a spring, though other elastic elements may alternatively be selected.

Further illustrated in the sixth embodiment shown in FIGS. 18-19, FIG. 18 is a structural schematic diagram of the sixth embodiment of the camera accessory of the present application, and FIG. 19 is a structural schematic diagram of the sixth embodiment of the camera accessory shown in FIG. 18 from another viewing angle;

In the sixth embodiment, the camera accessory components are designated with series numbering beginning with 600, wherein each component number corresponds to the numbering in the first embodiment. Except for the guide structure 63 and its related structures, other structures are substantially the same as those in the fourth embodiment, and specific details will not be reiterated herein.

The operational logic of the guide structure 63 in the sixth embodiment is consistent with the operational logic of the guide structure 63 in the second embodiment. The guide structure 63 comprises a guide hole 632 formed on the second mounting seat 61 and extending circumferentially, and a guide post 633 arranged on the contact holder 62. The guide post 633 is inserted through the guide hole 632, and the guide surface 631 is formed in the guide hole 632. The guide hole 632, similar to the guide groove 632, extends circumferentially and is inclined in the axial direction. To ensure stable movement of the contact holder 62, multiple sets of guide structures 63 may be provided.

The guide post 633 is inserted through the guide hole 632 and can project from the outer ring surface 613 of the second mounting seat 61, thus the guide post 633 can simultaneously serve as the locking post 623 as in the first embodiment, cooperating with the first claw 111 to achieve relative fixation between the contact holder 62 and the first mounting seat 11.

In this embodiment, the contact holder 62 further comprises a fixing ring 623, an elastic ring 624, and a holding portion 625, wherein the fixing ring 623 is fixedly arranged on the second mounting seat 61, the elastic ring 624 is fixedly engaged with the fixing ring 623, the holding portion 625 is rotatably arranged on the elastic ring 624, the holding portion 625 is configured to mount contacts 621, and the guide post 633 is arranged on the holding portion 625.

As in the fourth embodiment, in the sixth embodiment, a return elastic member is further arranged between the contact holder 62 and the second mounting seat 61. In this embodiment, the return elastic member comprises a spring, though other elastic elements may alternatively be employed. Specifically, a hook-shaped structure 626 may be arranged at one end of the contact holder 62, a fixed post 614 may be arranged on the second mounting seat 61, and the return elastic member is connected between the hook-shaped structure 626 and the fixed post 614.

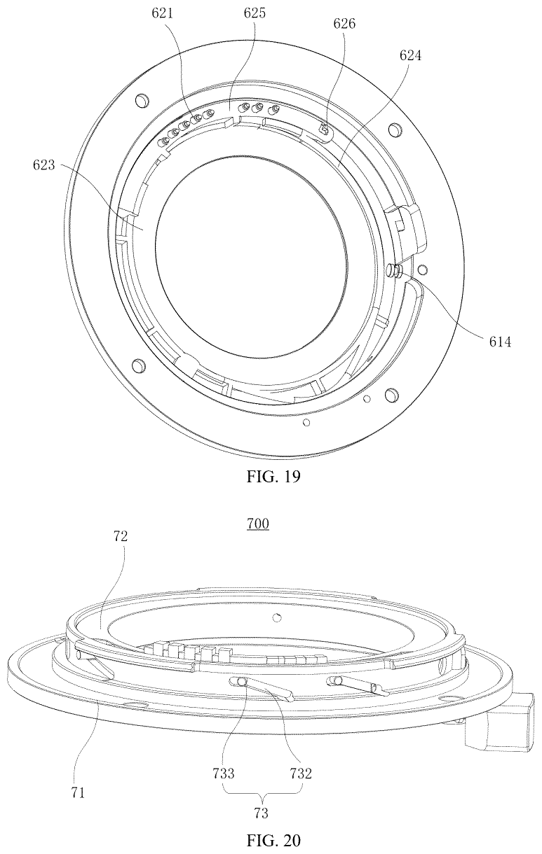

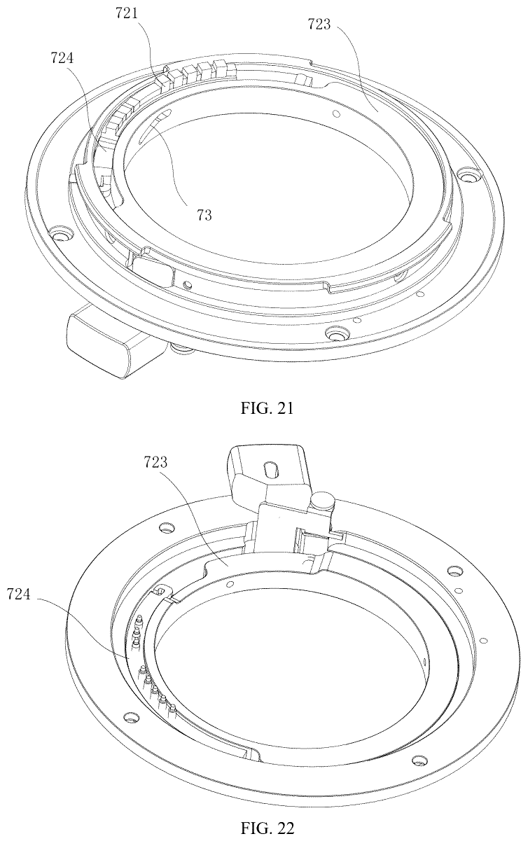

As illustrated in the seventh embodiment of FIGS. 20-22, FIG. 20 is a structural schematic diagram from a first perspective of the seventh embodiment of the camera accessory of the present application, FIG. 21 is a structural schematic diagram from a second perspective of the seventh embodiment of the camera accessory shown in FIG. 20, and FIG. 22 is a structural schematic diagram from a third perspective of the seventh embodiment of the camera accessory shown in FIG. 20.

In the seventh embodiment, the camera accessory is designated with series numbering beginning with 700, wherein each component number corresponds to the numbering in the fourth embodiment. Except for the guide structure 73 and its related structures, other structures are substantially the same as those in the first embodiment, and specific details will not be repeated herein.

The guide structure 73 in the fourth embodiment is substantially the same as the guide structure 63 in the sixth embodiment, wherein the guide structure 73 also comprises a guide post 733 and a guide hole 732. The specific difference lies in the arrangement of the contact holder 62. In the present embodiment, the contact holder 72 further comprises a fixing ring 723 and a holding portion 724, wherein the fixing ring 723 is fixedly arranged on the second mounting seat 71, and the holding portion 724 is rotatably engaged between the fixing ring 723 and the second mounting seat 71. A guide structure 73 is also arranged between the holding portion 724 and the fixing ring 723, with the guide post 733 arranged on the holding portion 724; the holding portion 724 is configured to accommodate the contact 721.

As in the fourth embodiment, in the seventh embodiment, a return elastic member is further arranged between the contact holder 72 and the second mounting seat 71. In this embodiment, the return elastic member is a spring, though other elastic elements may alternatively be selected.

In summary, the camera accessory shown in FIGS. 11-22 is configured to be mounted to a camera body having a first mounting seat. The camera accessory comprises: a second mounting seat configured to engage and connect with the first mounting seat; a contact holder arranged on the inner ring surface of the second mounting seat, wherein contacts are arranged on the contact holder and configured for electrical connection with the camera body; a guide structure arranged between the contact holder and the second mounting seat; when the contact holder rotates relative to the second mounting seat, the contact holder moves in the axial direction of the camera accessory under the action of the guide structure. According to the camera accessory of the present application, the contact holder can move axially up and down for electrical connection with the camera body after the second mounting seat is rotated into position, thereby avoiding friction between contacts during the rotation process and preventing wear.

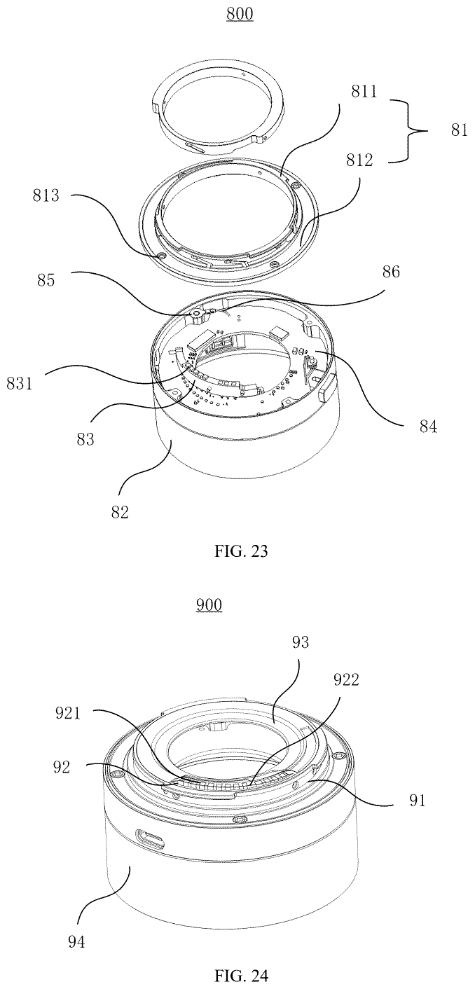

This application further discloses a camera accessory. For specific details, please refer to FIG. 23, which is an exploded structural schematic diagram of the eighth embodiment of the camera accessory of this application. The camera accessory 800 further comprises an accessory housing 82, a contact assembly 83, and a control circuit board 84.

The accessory housing 82 serves as the housing of the camera accessory 800, wherein the second mounting seat 81 is arranged at the end of the accessory housing 82. When the camera accessory 800 is a lens, an optical lens module, circuit boards and other structures are also arranged within the accessory housing 82. If the camera accessory 800 is an adapter ring, one end is configured with a second mounting seat 81 that engages with the camera body 100, while the other end is configured with a mounting seat that engages with an adapter lens, and a circuit structure may also be provided internally.

The second mounting seat 81 on the camera accessory 800 is annular in configuration, comprising an inner ring surface and an outer ring surface, wherein the outer ring surface engages with the first mounting seat 11, and the inner ring surface is provided with electrical connection contacts for electrical connection with the camera body 100. The contact assembly 83 is arranged on the inner ring surface of the second mounting seat 81, wherein the contact assembly 83 comprises contacts 831, and the contacts 831 are configured to establish electrical connection with the camera body 100.

The control circuit board 84 is arranged within the accessory housing 82, configured to provide electrical control for the camera accessory 800, and is electrically connected to the contacts 831. A grounding terminal is provided on the control circuit board 84, thereby enabling the grounding terminal of the control circuit board 84 to be utilized to achieve grounding when the camera accessory 800 is electrically connected to the camera body 100. In this embodiment, the second mounting seat 81 is utilized to achieve grounding, wherein the second mounting seat 81 is configured as a conductive material, such as metal, and is electrically connected to the grounding terminal of the control circuit board 84, thereby enabling grounding when the camera accessory 800 is electrically connected to the camera body 100.

The conductive second mounting seat 81 makes full contact with the first conductive mounting seat 11, eliminating the occurrence of poor contact issues, thereby ensuring stable grounding.

Specifically, the first mounting seat 11 comprises a first base ring 112 and first claws 111 arranged on the first base ring 112, and the second mounting seat 81 comprises a second base ring 812 and second claws 811 arranged on the second base ring 812. When the second mounting seat 81 rotates relative to the first mounting seat 11 between the first state and the second state, in the second state, the first base ring 112 and the second base ring 812 are fitted together in connection.

A metal plate 85 is connected to the side of the second base ring 812 that faces away from the first base ring 112, wherein the second base ring 812 is connected to the grounding terminal of the control circuit board 84 through the metal plate 85.

Specifically, the second base ring 812 is mounted on the accessory housing 82 by screws, wherein the second base ring 812 is provided with a plurality of fixing holes 813. The metal plate 85 can utilize the fixing holes 813 to connect to the second base ring, thereby simplifying the structure. The metal plate 85 is further provided with base connection holes 851, corresponding to the fixed holes 813. When the second mounting seat 81 is secured by bolts, studs, or screws, the metal plate 85 can be simultaneously fixed to the second mounting seat 81.

The metal plate 85 has a strip configuration with base connection holes arranged at one end and a ground terminal at the opposite end, wherein the ground terminal is connected to the grounding terminal of the control circuit board 84 via grounding wire 86.

In view of the grounding implementation achieved through the second mounting seat 81 in the present embodiment, the contact assembly 83 of the camera accessory 800 may omit grounding contacts and comprise only communication contacts and power contacts. During the installation process of camera accessory 800, the contacts may experience wear, therefore, grounding is not achieved through grounding contacts, but rather through the more stable connection of the mounting seat, which ensures secure grounding.

The camera accessory shown in FIG. 23 is configured to be mounted to a camera body having a first mounting seat; the camera accessory comprises: an accessory housing; a second mounting seat arranged at an end of the accessory housing, wherein the second mounting seat is configured to engage and connect with the first mounting seat; a contact assembly arranged on an inner ring surface of the second mounting seat, wherein the contact assembly comprises contacts configured to electrically connect with the camera body; a control circuit board arranged within the accessory housing, wherein the second mounting seat is electrically connected to a ground terminal of the control circuit board. The camera accessory of the present application utilizes the mounting seat to achieve grounding, providing more stable electrical grounding connection.

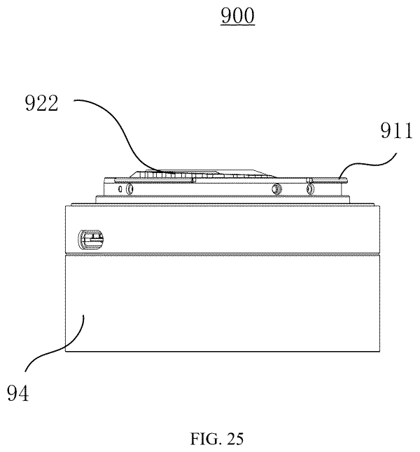

The present application further provides a camera accessory. For specific details, please refer to FIGS. 24-25, wherein FIG. 24 is a structural schematic diagram of the ninth embodiment of the camera accessory of the present application, and FIG. 25 is another structural schematic diagram of the ninth embodiment of the camera accessory shown in FIG. 24. In the camera body 100 to which the camera accessory 900 of this embodiment is adapted, the first mounting seat 11 is provided with a plurality of first contacts 112, wherein the plurality of first contacts 112 exhibit height difference in the axial direction of the first mounting seat 11.

On the camera body 100, in this embodiment the first contacts 112 are designed with height differences to reduce contact wear during rotation, corresponding to the camera body 100 having the first contacts 112. The camera accessory 900 of this embodiment further comprises a contact holder 92, wherein the contact holder 92 is arranged on the inner ring surface of the second mounting seat 91, the contact holder 92 is provided with a plurality of second contacts 921, and the second contacts 921 are configured for electrical connection with the first contacts 112.

The second contacts 921 are arranged on the holding surface 922 of the contact holder 92 facing toward the first mounting seat 11. To accommodate the first contacts 112 having height difference, the holding surface 922 may be configured with height difference, or alternatively, the second contacts 921 itself may be configured with height difference.

In this embodiment, the holding surface 922 is configured with height difference, and the second contacts 921 are positioned flush with the holding surface 922. The contacts 921 may be either metal post or metal plate, wherein the metal post is inserted within the contact holder 92, while the metal plate is attached to the holding surface 922.

The holding surface 922 comprises a smooth surface formed in accordance with the height variation trend of the plurality of first contacts 112. By configuring the holding surface 922 as a smooth surface, contact between the contacts remains relatively smooth during the relative rotational mounting process between the camera accessory 900 and the camera body 100, thereby reducing wear. Meanwhile, the retaining member 922 with smooth surface also features simpler processing technology and lower cost.

Specifically, the plurality of first contacts 112 are respectively positioned at a first height and a second height in the axial direction of the first mounting seat 11, and are arranged sequentially along the first height and the second height. The holding surface is formed as an inclined surface following the height variation of the first contacts 112, namely an inclined surface that is tilted relative to the axial direction along the inner ring surface.

The holding surface may be inclined corresponding to a portion of the first contacts 112, or may be inclined corresponding to all of the first contacts 112. In this embodiment, the holding surface is inclined corresponding to all first contacts 112, with the degree of inclination extending from the first contact at one end to the first contact at the other end among the plurality of first contacts 112.

To simplify the structure of the camera accessory 900, the contact holder 92 is semi-annular in configuration, with the arc corresponding to the number of contacts. A complete annular fixing ring 93 is also provided on the inner ring surface of the second mounting seat 91 to secure the contact holder 92, with the contact holder 92 arranged between the fixing ring 93 and the second mounting seat 91. The surface of the fixing ring 93 facing the first mounting seat 11 is perpendicular to the axial direction of the second mounting seat 91, namely arranged on a planar surface rather than on an inclined surface.

Both the fixing ring 93 and the contact holder 92 are plastic components to ensure insulation between the contact holders 92. The camera accessory 900 further comprises an accessory housing 94, wherein the accessory housing 94 serves as the housing of the camera accessory 900, the second mounting seat 91 is arranged at an end of the accessory housing 94, and when the camera accessory 900 constitutes a lens, the accessory housing 94 further accommodates structures comprising an optical lens module and circuit boards. Where the camera accessory 900 is an adapter ring, one end thereof is provided with a second mounting seat 91 configured to engage with the camera body 100, while the other end is provided with a mounting seat configured to engage with an adapter lens, wherein circuit structure may also be arranged internally therein.

In summary, the camera accessory shown in FIGS. 24-25 is configured for mounting to a camera body having a first mounting seat. The first mounting seat is provided with a plurality of first contacts, wherein the plurality of first contacts exhibit height difference along the axial direction of the first mounting seat. The camera accessory comprises: a second mounting seat configured to engage and connect with the first mounting seat; a contact holder arranged on the inner ring surface of the second mounting seat; a plurality of second contacts are arranged on the holding surface of the contact holder facing the first mounting seat, wherein the second contacts are configured to establish electrical connection with the first contacts; the second contacts are flush with the holding surface, wherein the holding surface comprises a smooth surface formed in accordance with the height variation pattern of the plurality of first contacts. The camera accessory of the present application is adaptable to camera bodies having contacts with height differentials and features simplified manufacturing processes and reduced cost.

The terms “first,” “second,” and “third” employed in the present application are used solely for descriptive purposes and shall not be construed as indicating or implying relative importance or implicitly specifying the quantity of the referenced technical features. Accordingly, features designated as “first,” “second,” and “third” may explicitly or implicitly include at least one such feature. In the description of this application, “multiple” means at least two, for example, two, three, etc., unless otherwise specifically and clearly defined. All directional indicators in the embodiments of this application (such as up, down, left, right, front, back . . . ) are used solely to explain the relative positional relationships and movement conditions between various components under a specific orientation (as shown in the accompanying drawings). If this specific orientation changes, the directional indicators shall correspondingly change accordingly. Furthermore, the terms “comprise” and “have,” as well as any variations thereof, are intended to cover non-exclusive inclusion. For example, a process, method, system, product, or apparatus that comprises a series of steps or elements is not limited to the specifically listed steps or elements, but may optionally further include unlisted steps or elements, or may optionally further include other steps or elements inherent to such processes, methods, products, or apparatus.

The foregoing embodiments are merely illustrative of the present application and shall not limit the patent scope thereof. Any equivalent structural modifications or equivalent process variations made utilizing the contents of the present specification and drawings, whether applied directly or indirectly in other related technical fields, are likewise encompassed within the patent protection scope of the present application.

What is claimed is:

1. A camera accessory, wherein the camera accessory is configured to be mounted to a camera body having a first mounting seat, the first mounting seat comprising a plurality of first claws; the camera accessory comprising:
a second mounting seat, the second mounting seat comprising a plurality of second claws; the second mounting seat being configured to rotate relative to the first mounting seat between a first state and a second state, wherein in the first state, the second claws are each inserted between the first claws; wherein in the second state, the second claws engage with the first claws;
a latch structure, wherein the latch structure is movably arranged on an outer ring surface of the second mounting seat that engages with the first claw, and when the second mounting seat rotates relative to the first mounting seat between the first state and the second state, the latch structure retracts into the outer ring surface; when the second mounting seat is in the second state relative to the first mounting seat, the latch structure projects from the outer ring surface and engages with the first claw to restrict the second mounting seat from rotating from the second state to the first state.

2. The camera accessory according to claim 1, wherein the camera accessory further comprising:
an accessory housing, wherein the second mounting seat is arranged at an end of the accessory housing;
an unlocking button, wherein the unlocking button is arranged on a side surface of the accessory housing, connected to the latch structure, acting upon the latch structure to cause the latch structure to retract into the outer ring surface, thereby releasing the engagement between the latch structure and the first claw.

3. The camera accessory according to claim 2, wherein the latch structure is elastically movably arranged relative to the outer ring surface in an axial or radial direction of the camera accessory, and when the second mounting seat rotates relative to the first mounting seat between a first state and a second state, the latch structure is pressed into the outer ring surface by the first claw; when the second mounting seat is in the second state relative to the first mounting seat, the latch structure is ejected from the outer ring surface.

4. The camera accessory according to claim 3, wherein a linkage structure is arranged between the unlocking button and the latch structure, the unlocking button being movable radially to drive the latch structure to move axially through the linkage structure.

5. The camera accessory according to claim 4, wherein a guide portion is fixedly arranged on the second mounting seat, and an axial guide groove is provided on the guide portion; the latch structure is arranged on the guide portion and moves axially along the axial guide groove;
the linkage structure comprising:
a V-shaped transmission member, wherein the turning point of the V-shaped transmission member is rotatably arranged on the guide portion, with one end connected to the latch structure and another end connected to the unlocking button.

6. The camera accessory according to claim 5, wherein a return snap spring is arranged at the rotational connection between the V-shaped transmission member and the guide portion, and in the natural state of the return snap spring, the latch structure projects from the outer ring surface.

7. The camera accessory according to claim 3, wherein the unlocking button abuts against the latch structure, the unlocking button moves radially and drives the latch structure to move radially.

8. A camera accessory, wherein the camera accessory is configured to be mounted to a camera body having a first mounting seat, the camera accessory comprising:
a second mounting seat configured to be engaged and connected with the first mounting seat;
a contact holder rotatably arranged on an inner ring surface of the second mounting seat, wherein contacts are arranged on the contact holder and configured to be electrically connected to the camera body;
a guide structure arranged between the contact holder and the second mounting seat; when the contact holder rotates relative to the second mounting seat, the contact holder moves in the axial direction of the camera accessory under an action of the guide structure.

9. The camera accessory according to claim 8, wherein the guide structure is formed with a guide surface, the guide surface extends in the circumferential direction and is inclined in the axial direction; the contact holder abuts against the guide surface, and when the contact holder rotates relative to the second mounting seat, the guide surface generates an axial force on the contact holder to cause the contact holder to move in the axial direction.

10. The camera accessory according to claim 9, wherein the guide structure comprises a guide post arranged on the contact holder and a guide plate arranged on the second mounting seat; the guide plate is fixed to an end surface of the second mounting seat facing away from the first mounting seat, the guide surface is formed on the guide plate, and the guide post abuts against the guide surface.

11. The camera accessory according to claim 10, wherein the contact holder comprises a rotating ring, an elastic ring, and a holding portion, the rotating ring is rotatably engaged with an inner ring surface of the second mounting seat, the elastic ring connects the rotating ring and the holding portion, the holding portion is configured to mount contacts; the guide post is arranged on the holding portion.

12. The camera accessory according to claim 9, wherein the guide structure comprises a guide groove and a guide post, the guide groove being formed in one of the second mounting seat and the contact holder, the guide post being arranged on the other one of the second mounting seat and the contact holder; the guide post is inserted through the guide groove, the guide surface being formed on the guide groove.

13. The camera accessory according to claim 12, wherein the guide structure further comprises a mounting slot connected to the guide groove, during the process of the contact holder being axially mounted to the second mounting seat, the guide post enters the guide groove from the mounting slot;
a limiting structure is arranged between the contact holder and the second mounting seat to restrict movement of the guide post within the guide groove.

14. The camera accessory according to claim 13, wherein the limiting structure comprises a limiting hole extending circumferentially on the second mounting seat, and a limiting post arranged on the contact holder, the limiting post being inserted into the limiting hole.

15. The camera accessory according to claim 9, wherein the guide structure comprises a guide hole formed on the second mounting seat and extending circumferentially, and a guide post arranged on the contact holder, the guide post being inserted through the guide hole, the guide surface being formed in the guide hole.

16. The camera accessory according to claim 9, wherein the guide surface is inclined in a direction away from the first mounting seat along the mounting rotation direction of the camera accessory relative to the camera body.

17. The camera accessory according to claim 8, wherein the first mounting seat comprises a plurality of first claws, the second mounting seat comprises a plurality of second claws, the second mounting seat rotates relative to the first mounting seat between a first state and a second state, and in the first state, the second claws are each inserted between the first claws; wherein in the second state, the second claws engage with the first claws;
the contact holder is connected with a locking post, the locking post projecting from the outer ring surface of the second mounting seat, wherein during the process of the second mounting seat rotating from the first state to the second state relative to the first mounting seat, the first claw abuts against the locking post, thereby causing the contact holder and the first mounting seat to be relatively fixed in the circumferential direction, wherein the second mounting seat and the contact holder undergo relative rotation, whereby the contact holder is subjected an axial acting force to move axially in a direction approaching the first mounting seat, thereby achieving electrical connection with the camera body.

18. The camera accessory according to claim 17, wherein when the second mounting seat is in a first state relative to the first mounting seat, the contact holder is in a first position relative to the second mounting seat; when the second mounting seat is in a second state relative to the first mounting seat, the contact holder undergoes positional changes in both axial and circumferential directions relative to the second mounting seat, and is in a second position;
a return elastic member is arranged between the contact holder and the second mounting seat, whereby the contact holder can return from the second position to the first position under the action of the return elastic member.

19. The camera accessory according to claim 8, wherein the surface of the contact holder facing the first mounting seat has a height difference, and the contacts are arranged flush with the surface having the height difference; or,
the surface of the contact holder facing toward the first mounting seat is planar, the contacts are metal posts, with portions of the contacts projecting from the contact holder so as to form a height difference between the contacts.

20. A camera system, characterized in that the camera system comprises the camera accessory according to claim 1, and a camera body adapted to the camera accessory.
